(19) United States
(12) Patent Application Publication
(10) Pub. No.: US 2022/0334407 A1
(43) Pub. Date: Oct. 20, 2022

(54) EYEGLASSES WITH HIDDEN BRIDGE

(71) Applicant: TSAIR YUARN INDUSTRIAL CO., LTD., Tainan City (TW)

(72) Inventor: PAO-MING HUANG, TAINAN CITY (TW)

(21) Appl. No.: 17/232,625

(22) Filed: Apr. 16, 2021

(51) Int. Cl. G02C 5/02

(52) U.S. Cl. CPC G02C 5/02

(57) ABSTRACT

Eyeglasses with a hidden bridge are revealed. The eyeglasses include at least one frame for supporting at least one lens and a bridge arranged at the frame. The frame is provided with a bridge assembly portion which is inverted U-shaped corresponding to a nose of a human face. The bridge is a U-shaped support fixed on a top of a transverse portion of the bridge assembly portion with a U-shaped opening facing the human face so that a bottom surface of the bridge is above the transverse portion of the bridge assembly portion. Thereby the bridge is hidden behind the lens. The bridge is invisible while looking at the eyeglasses from a front side. Thus value and economic benefits that come with the eyeglasses are both increased.

### BACKGROUND OF THE INVENTION

### Field of the Invention

The present invention relates to eyeglasses, especially to eyeglasses which includes a bridge with a hidden design so that the bridge is invisible while looking at the eyeglasses from a front side of the eyeglasses.

### Description of Related Art

Generally, eyeglasses include a bridge which makes contact with the nose of user's face and locates on the middle of the frame. Thus the eyeglasses is supported and fixed onto the user's face by the bridge.

In conventional eyeglasses, the bridge may be integrated with the frame into one part or an independent part arranged at a nose portion of the frame located above the nose. However, no matter as an integrated part of the frame or as an independent part, the bridge is usually disposed under a transverse portion of the frame such as those revealed in Taiwanese Pat. No. 1320491B, Taiwanese Pat. Pub. No. 200821660A, Taiwanese Pat. No. M574248U, Taiwanese Pat. No. M567876U, Taiwanese Pat. No. M544639U, and Taiwanese Pat. No. M544006U. While viewing the glasses, the bridge is exposed and seen clearly. The exposure of the bridge has a significant impact on the overall aesthetics and value of the eyeglasses.

Thus there is room for improvement and there is a need to provide eyeglasses with novel structure to addresses the issues presented in use.

### SUMMARY OF THE INVENTION

Therefore it is a primary object of the present invention to provide eyeglasses in which a bridge is hidden behind a lens so that the bridge is invisible while looking at the eyeglasses from a front side of the eyeglasses. Thereby both the overall aesthetics and economic benefits of the eyeglasses are improved.

In order to achieve the above object, eyeglasses with a hidden bridge according to the present invention include at least one frame for supporting at least one lens and a bridge arranged at the frame. The frame is provided with a bridge assembly portion which is corresponding to a nose of a human face and composed of a transverse portion on a top thereof and an inner edge portion extending downward from each of two ends of the transverse portion. Thus the bridge assembly portion is inverted U shaped. The bridge is a U-shaped support fixed on the transverse portion with a U-shaped opening facing the human face and a bottom surface of the bridge is at the higher level than a bottom surface of the transverse portion.

A recess portion is disposed on a surface of the transverse portion facing the human face, and at least one fastening hole is mounted on the recess portion. A protruding portion is arranged at the bottom surface of the bridge and corresponding to the recess portion for being mounted into the recess portion while at least one through hole is disposed on the protruding portion and corresponding to the fastening hole. At least one fastener is passed through the through hole and fastened in the fastening hole for fixing the bridge to the transverse portion.

The present invention has the following advantages. By the bridge which is fixed on the transverse portion of the bridge assembly portion and having the bottom surface at the higher level than the bottom surface of the transverse portion and the U-shaped opening facing the human face, the bridge is hidden behind the lens. While looking at the eyeglasses from the front side of the eyeglasses, the bridge is invisible. Thereby the aesthetics and value of the eyeglasses are improved and economic benefits that come with the eyeglasses are further increased.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an exploded view of an embodiment according to the present invention;

FIG. 2 is a perspective view of an embodiment according to the present invention;

FIG. 3 is a schematic drawing showing an embodiment in use according to the present invention;

FIG. 4 is a partial sectional view of an embodiment according to the present invention.

### DETAILED DESCRIPTION OF THE PREFERRED EMBODIMENT

In order to learn technical content and functions of the present invention more completely and clearly, please refer to the following embodiments with detailed descriptions together with the related figures and reference signs therein.

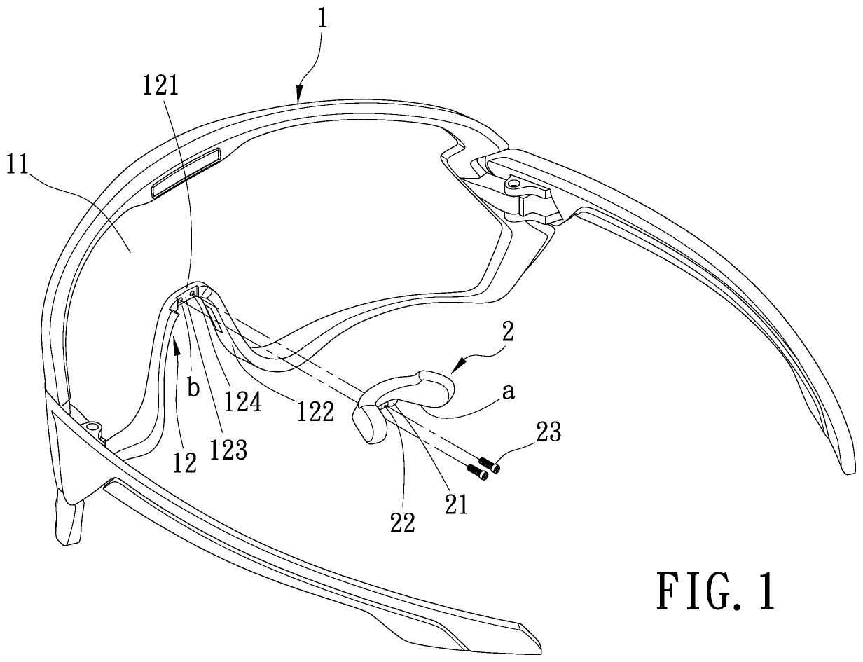

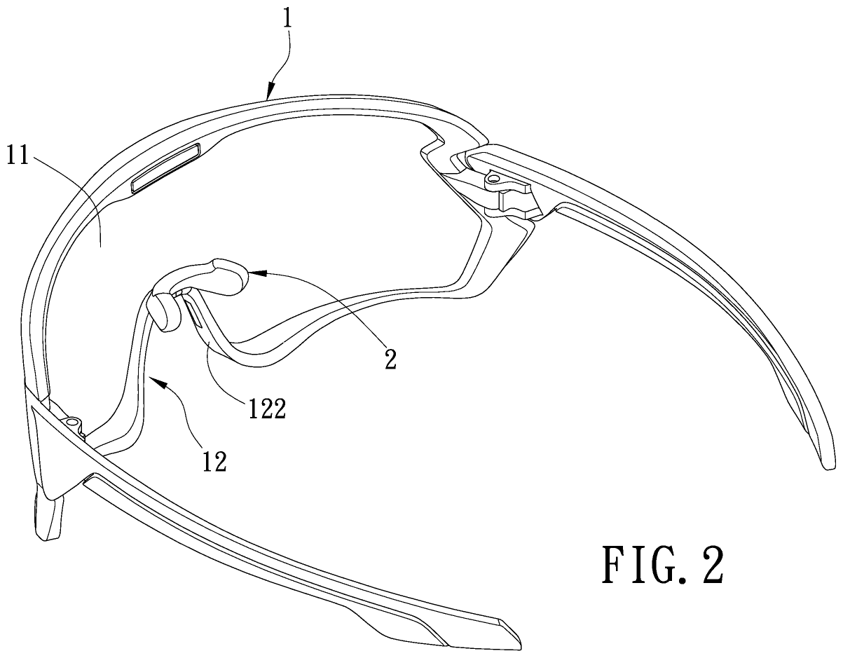

Refer to FIG. 1 and FIG. 2, eyeglasses with a hidden bridge of the present invention includes a frame 1 and a bridge 2.

The frame 1 is used to hold at least one lens 11. As shown in FIG. 1-4, the frame 1 is used for supporting and fixing a lens 11 so that the eyeglasses have only one lens 11. Besides the lens 11, the frame 1 further includes a bridge assembly portion 12 which is corresponding to a nose of a human face and composed of a transverse portion 121 on a top thereof and an inner edge portion 122 extending downward from each of two ends of the transverse portion 121. The bridge assembly portion 12 which is formed by the transverse portion 121 and the inner edge portions 122 is in an inverted U shape.

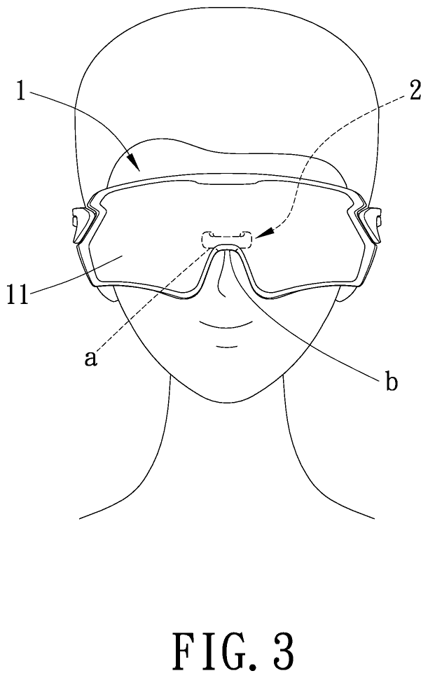

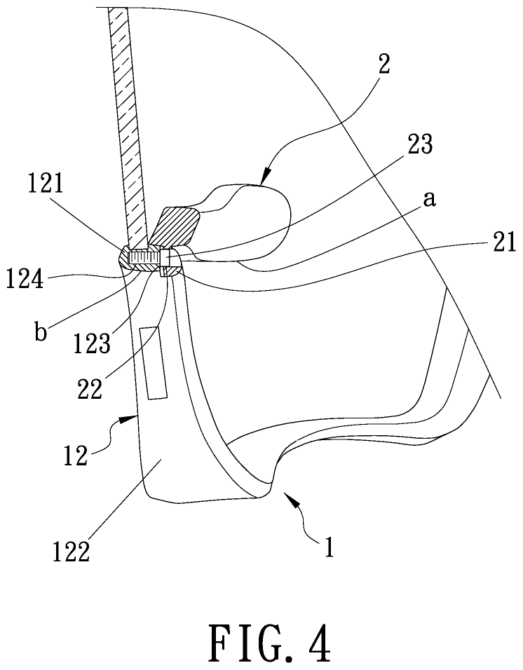

The bridge 2 which is mounted to the bridge assembly portion 12 of the frame 1 is a U-shaped support fixed on the transverse portion 121 of the bridge assembly portion 12 with a U-shaped opening facing the human face while a bottom surface a of the bridge 2 is at the higher level than a bottom surface b of the transverse portion 121 (also with reference to FIG. 3 and FIG. 4).

Refer to FIG. 1 and FIG. 4, the transverse portion 121 is further provided with a recess portion 123 formed on a surface of the transverse portion 121 facing the human face, and at least one fastening hole 124 arranged at the recess portion 123. The bridge 2 consists of a protruding portion 21 which is disposed on the bottom surface a of the bridge 2 and corresponding to the recess portion 123 for being mounted into the recess portion 123, at least one through hole 22 arranged at the protruding portion 21 and corresponding to the fastening hole 124, and at least one fastener 23 passed through the through hole 22 and fastened in the fastening hole 124 for fixing the bridge 2 to the transverse portion 121 of the bridge assembly portion 12.

Refer to FIG. 3 and FIG. 4, the U-shaped bridge 2 is fixed on the transverse portion 121 of the bridge assembly portion 12 with the U-shaped opening facing the human face. Moreover, the bottom surface a of the bridge 2 is at the higher level than the bottom surface b of the transverse portion 121 so that the bridge 2 is hidden behind the lens 11. After the user wearing the eyeglasses, people who look at the eyeglasses from the front side of the eyeglasses will not see the bridge 2. The overall appearance of the eyeglasses is more concise. Thus the aesthetics and value of the eyeglasses are boosted and economic benefits that come with the eyeglasses are further increased.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. Eyeglasses with a hidden bridge comprising
at least one frame for supporting at least one lens, and a bridge arranged at the frame;
wherein the frame is provided with a bridge assembly portion which is corresponding to a nose of a human face and composed of a transverse portion on a top thereof and an inner edge portion extending downward from each of two ends of the transverse portion; thus the bridge assembly portion is inverted U shaped; wherein the bridge is a U-shaped support fixed on the transverse portion with a U-shaped opening facing the human face and a bottom surface of the bridge is at the higher level than a bottom surface of the transverse portion.

2. The device as claimed in claim 1, wherein a recess portion is disposed on a surface of the transverse portion facing the human face and at least one fastening hole is mounted on the recess portion; wherein a protruding portion is arranged at the bottom surface of the bridge and corresponding to the recess portion for being mounted into the recess portion while at least one through hole is disposed on the protruding portion and corresponding to the fastening hole; wherein at least one fastener is passed through the through hole and fastened in the fastening hole for fixing the bridge to the transverse portion.
